(19) United States
(12) Patent Application Publication
(10) Pub. No.: US 2008/0310452 A1
(43) Pub. Date: Dec. 18, 2008

(54) DATA LINK LAYER HEADERS

(75) Inventors: Ramanuja VEDANTHAM, Dallas, TX (US); Shantanu KANGUDE, Dallas, TX (US); Harshal S. CHHAYA, Plano, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/140,012

(22) Filed: Jun. 16, 2008

Related U.S. Application Data
(60) Provisional application No. 60/943,909, filed on Jun. 14, 2007.
(60) Provisional application No. 60/945,127, filed on Jun. 20, 2007.

(51) Int. Cl. H04L 29/06

(52) U.S. Cl. 370/474

(57) ABSTRACT

A system for communicating protocol layer processing information is disclosed herein. A transmitter includes a protocol layer header generator that generators a header for a first protocol data unit. The header generator provides a first header comprising a first sequence number field that determines the order in which a receiving entity present the first data unit to higher protocol layer. The sequence number field varies in length. A receiver includes a protocol layer header parser that parses a header of a first protocol data unit. The header parser parses a first header comprising a first sequence number field that determines the order in which the first data unit is presented to a higher protocol layer. The sequence number field varies in length.

### CROSS-REFERENCE TO RELATED APPLICATIONS

The present application claims priority to U.S. provisional patent application Ser. No. 60/943,909, filed Jun. 14, 2007, and entitled “PDCP-RLC-MAC Header Format for LTE” hereby incorporated herein by reference. The present application additionally claims priority to U.S. provisional patent application Ser. No. 60/945,127, filed Jun. 20, 2007, and entitled “PDCP-RLC-MAC Header Format for LTE” hereby incorporated herein by reference.

### BACKGROUND

With the proliferation of modern wireless technologies, networked devices have become nearly ubiquitous. Networked devices often employ a multi-layered protocol architecture to simplify communications. The layers serve to isolate each function to a particular hierarchical system, thereby isolating other systems within the protocol hierarchy from the details of functionalities implemented in disparate layers.

Network protocol layering is often based on the Open Systems Interconnection Model (“OSI”), as specified in ITU-T Recommendation X.200. The OSI model specifies seven protocol layers traversed by data as it passes between the transmission media and the relevant application. Each layer may copy the data received from the previous layer, and pass a modified version of the data to the subsequent layer for further processing.

The first and lowest layer of a protocol stack is often termed the “physical” layer. The physical layer provides the network device with means to access the physical media interconnecting devices, and to transmit and receive bit streams via that media.

The data link layer resides atop, and is serviced by, the physical layer of the network stack. The data link layer may provide a variety of services to higher levels, and therefore comprise a number of functionalities. Representative data link layer functionalities include error correction by automatic retransmission request, ciphering and deciphering of data units, and segmentation and reassembly of data units. The data link layer may be further sub-divided into a number of sub-layers to implement the required functionalities. Each sub-layer receives data from the previous sub-layer, processes the data, and passes the processed data to the next sub-layer for further processing. Sub-layer processing may include copying, as well as other manipulations of the data.

The network layer (layer 3) is located above the data link layer. The network layer provides for connection establishment and release between communicating applications. A wide variety of other functions, such as routing and relay services, may reside at the network layer. The internet protocol is a well-known example of a network layer protocol.

Generally, each protocol layer or sub-layer inserts a header into a data unit the protocol layer prepares for transmission. The header contains information regarding the operations performed by the layer in formatting the data unit. A receiving entity at the corresponding protocol layer of a receiving device parses the header and uses the information to reconstruct a data unit provided to the next higher protocol layer. With wireless network speeds increasing dramatically, from 10-100 Kbps in 2G networks, to 1-10 Mbps in 3G networks, to 100 Mbps in 4G networks, efficient real-time processing of the various protocol layers becomes increasingly important. Thus, the protocol layer headers and the information contained therein should be optimized to enable processing efficiency.

### SUMMARY

Accordingly, various techniques for providing and parsing a header of a protocol data unit are herein disclosed. In accordance with at least some embodiments, a transmitter includes a protocol layer header generator. The protocol layer header generator generates a header for a first protocol layer data unit. The header generator provides a first header that includes a first sequence number field that determines the order in which a receiving entity presents at least a portion of the first data unit to a higher protocol layer. The sequence number field varies in length.

In other embodiments, a receiver includes a protocol layer header parser. The protocol layer parser parses a header of a first protocol data unit. The header parser parses a first header comprising a first sequence number field that determines the order in which at least a portion of the first data unit is presented to a higher protocol layer. The sequence number field varies in length.

### BRIEF DESCRIPTION OF THE DRAWINGS

For a detailed description of exemplary embodiments of the invention, reference will now be made to the accompanying drawings in which:

FIG. 1 shows an illustrative wireless network in accordance with various embodiments;

FIG. 2 shows an illustrative protocol stack and illustrative sub-layers of the data link layer of the protocol stack in accordance with various embodiments;

FIG. 3 shows as an illustrative transfer between wireless devices including protocol stacks in accordance with various embodiments;

FIG. 4 shows an illustrative example of layer 2 data unit composition in accordance with various embodiments;

FIG. 5 shows an illustrative Radio Link Control (“RLC”) sub-layer header in accordance with various embodiments;

FIG. 6 shows an illustrative RLC PDU including 2 RLC SDUs with no resegmentation and a corresponding RLC PDU header in accordance with various embodiments;

FIG. 7 shows an illustrative RLC PDU including a single RLC SDU with no resegmentation and a corresponding RLC PDU header in accordance with various embodiments;

FIG. 8 shows an illustrative RLC PDU including a single RLC SDU with resegmentation and a corresponding RLC PDU header in accordance with various embodiments;

FIG. 9 shows an illustrative RLC PDU including two RLC SDUs with resegmentation and a corresponding RLC PDU header in accordance with various embodiments; and

FIG. 10 shows an illustrative system for constructing and transmitting, and for receiving and parsing data link layer headers in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. The term “system” refers to a collection of two or more hardware and/or software components, and may be used to refer to an electronic device or devices, or a sub-system thereof. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment. While embodiments of the present disclosure are described primarily in the context of wireless communication systems, those skilled in the art will recognize that embodiments are applicable to data link layer protocols in a variety of communication and networking systems employing wire, optical and other transmission media. The present disclosure encompasses all such embodiments.

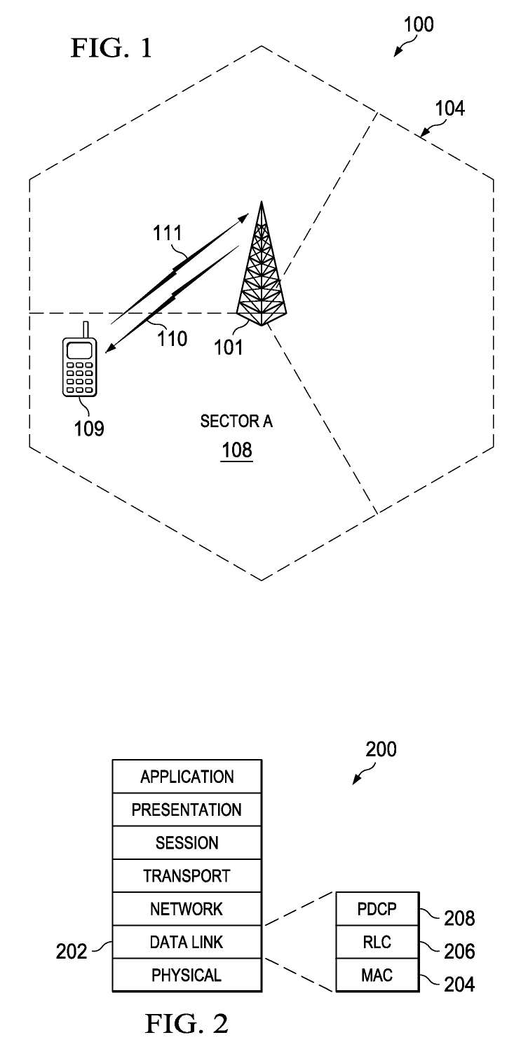

FIG. 1 shows an illustrative wireless telecommunications network 100. The illustrative wireless telecommunications network includes base station 101, though in practice, a wireless telecommunications network may include more base stations than illustrated. A base station may also be known as a fixed access point, a Node B, an e-Node B, etc. Base station 101 is operable over cell 104. The cell 104 is further divided into sectors. In the illustrated network, the cell 104 is divided into three sectors. Cellular telephone or other user equipment (“UE”) 109 is shown in sector A 108, which is within cell 104. Though as a matter of simplicity only a single UE is shown, in practice system 100 may include any number of UEs. The UE 109 may also be called a mobile terminal, a mobile station, etc. Base station 101 transmits to UE 109 via down-link 110, and receives transmissions from UE 109 via up-link 111.

Message transfer between base station 101 and UE 109 is facilitated by multi-layer protocol stacks. Generally, each layer and/or sub-layer of a transmitter protocol stack adds a header to the data unit passed the next lower layer or sub-layer. The headers include fields identifying the operations performed at that protocol layer. Each layer or sub-layer of a receiver protocol stack parses the header inserted in the corresponding transmission layer to allow reconstruction of a data unit provided to the next higher layer or sub-layer. As disclosed herein, base station 101 and UE 109 include embodiments of the present disclosure to provide efficient generation and parsing of data link layer headers.

FIG. 2 shows an illustrative seven layer protocol stack 200. The various layers of the stack may be further divided in sub-layers. As illustrated, the data link layer 202 of the exemplary protocol stack may be further sub-divided into multiple sub-layers as prescribed by, for example, the Long Term Evolution (“LTE”) wireless telecommunication standard of the Third Generation Partnership Project (“3GPP”). In FIG. 2, the data link layer 202 comprises a Media Access Control (“MAC”) sub-layer 204, a Radio Link Control (“RLC”) sub-layer 206, and a Packet Data Convergence Protocol (“PDCP”) sub-layer 208. Note that the data link layer 202 may comprise various other sub-layers not illustrated here, and the invention of the present disclosure is intended to accelerate processing across all protocol stack layers and the associated sub-layers.

Servicing the protocol stack layers, for example, the data link layer 202 requires a substantial amount of data packet manipulation and intensive bit level data processing. The above-mentioned sub-layers of the data link layer may, for example, add/remove headers, encrypt/decrypt payloads, segment/reassemble data blocks, concatenate data units, pad data units, compress/decompress headers, etc. These are examples of operations the performance of which may be communicated through headers constructed at the various sub-layers of the data link layer 202.

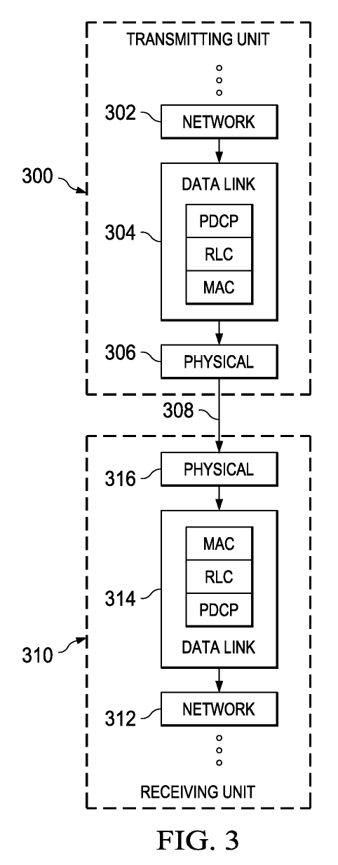

FIG. 3 shows an illustrative transfer between wireless devices including protocol stacks in accordance with embodiments of the invention. A message originates in the network layer 302 (layer 3), or possibly a layer above the network layer 302 of transmitting unit 300. The message is passed down to layer 2, the data link layer 304, for processing in the various sub-layers. For example, PCDP sub-layer processing may comprise internet protocol (“IP”) header compression and/or data encryption and/or addition of PDCP headers. RLC sub-layer processing may comprise segmentation, the decomposition of the PCDP data unit into multiple RLC data units when the PDCP data unit is larger than the RLC data unit, and addition of RLC headers. MAC sub-layer processing may comprise assembling multiple RLC data units into a larger MAC data unit, prefixing a header to the data unit, and encrypting the data. MAC sub-layer data units are delivered to the physical layer 306 for transmission via media 308 to the receiving unit 310.

The protocol stack of receiving unit 310 reverses the processing applied in the protocol stack of transmitting unit 300 to reconstruct the message passed from network layer 302 to the data link layer of transmitting unit 300. Reversal of the processing applied in the transmitting unit 300 protocol stack is enabled by the headers prefixed to the data unit at each layer/sub-layer. Error correction techniques may also be applied in the sub-layers of the data link layer 314 to ensure error free delivery of data units.

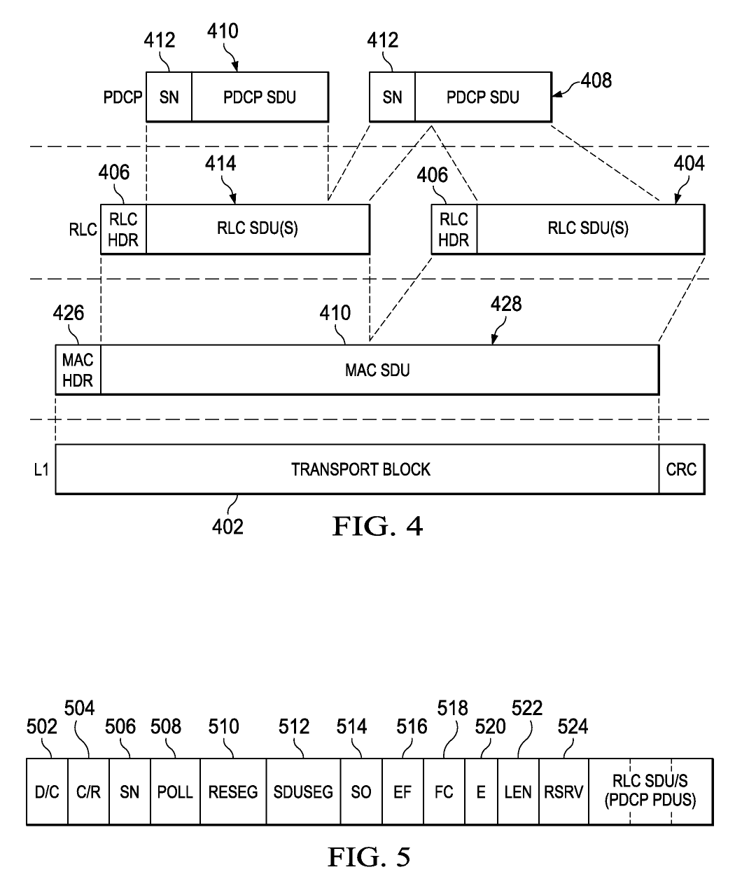

FIG. 4 shows an illustrative example of layer 2 data unit composition in accordance with various embodiments. An upper layer protocol data unit (“PDU”) is presented to the PDCP sub-layer, and a PDCP PDU 410, 408 is formed that includes the upper layer PDU. A header including a sequence number field (“SN”) 412 is added to the data unit. The SN 412 can be, for example, a count of upper level data units received for transmission. Inclusion of the SN 412 ensures in sequence delivery of data units to the layer above the PDCP sub-layer of a receiving entity. Some embodiments may include a 4 byte SN 412, but no particular sequence number field length is required. PDCP sub-layer processing of can further include application of compression to a header included in the data unit. For example, Robust Header Compression (“ROHC”) (RFC 3095, 3843, 4996, 4995) can be applied to compress an internet protocol (“IP”) header, user datagram protocol (“UDP”) header, real-time transport protocol (“RTP”) header, transmission control protocol (“TCP”) header, etc. of the data unit. Ciphering can also be applied in the PDCP sub-layer.

The PDCP PDU 410, 408 is presented to the RLC sub-layer. Functions performed in the RLC sub-layer include concatenation and/or segmentation of RLC service data units (SDUs) into an RLC PDU, addition of an RLC header 406, and retransmission of RLC PDUs using automatic repeat request (“ARQ”). Retransmitted RLC PDUs can be resegmented as required for inclusion in a subsequent RLC PDU. The RLC sub-layer may process data units in a acknowledged mode (“AM”) that provides concatenation and segmentation and further provides guaranteed data unit delivery by application of ARQ, an unacknowledged mode (“UM”) that provides concatenation and segmentation, but does not provide guaranteed delivery, or transparent mode (“TM”) that provides neither concatenation, nor segmentation, nor guaranteed delivery. The header 406 includes information sufficient to allow the RLC sub-layer of a receiving entity to reconstruct the PDCP PDUs 410, 408 for presentation to the PDU sub-layer. FIG. 4 shows RLC PDU 414 including the entirety of PDCP PDU 410 and a first portion of PDCP PDU 408. RLC PDU 404 includes the remainder of PDCP PDU 408.

RLC PDUs 404, 414 are presented to the media access control (“MAC”) sub-layer where multiple data units may be incorporated into a MAC PDU 428 for transmission to a single receiver, for example, a UE (e.g., UE 109). Multiple data units incorporated into a block may comprise data units of multiple flows. For each MAC SDU 410 incorporated into the MAC PDU 428, the MAC sub-layer also adds a header 426 to the MAC PDU 428.

The MAC PDU 428 is presented the physical layer where a transport block 402 comprising the MAC PDU 428 is formed for transmission to a receiving unit (e.g., UE 109).

As explained above, the headers added at each layer and/or sub-layer include information describing the operations performed to construct a data unit at that particular layer/sub-layer. A receiving entity applies the header information to reverse the operations performed at the corresponding layer/sub-layer of the transmitter to construct a data unit for presentation to an upper layer/sub-layer. Accordingly, embodiments of the present disclosure provide a variety of header information. Embodiments provide headers consisting of an integral number of bytes to enhance parsing efficiency at the receiver. FIG. 5 shows an illustrative RLC sub-layer header in accordance with various embodiments. Various fields are illustrated and not all fields are required in all embodiments. Moreover, a field need not occupy the same position in a header in all embodiments. Each field applicable to an embodiment is described below.

A data/control field (“D/C”) 502 identifies the RLC PDU 414 as either a data PDU or a control PDU. Control PDUs include PDU containing status regarding AM PDUs received and AM PDUs not received. Data PDUs include PDCP PDUs 408, 410. In some embodiments, the D/C field consists of a single bit, but embodiments are not limited to any particular field size.

A sequence number field (“SN”) 506 is assigned to each RLC PDU 414, 404. The number of bits included in the SN field varies to allow reduced overhead in situations where a longer SN field is unnecessary. For example, a shortened SN 506 field can be used for voice-over-IP (“VOIP”) and other low-data rate, real-time traffic employing small SDUs. Generally, in such cases the number of unacknowledged RLC PDUs is relatively small allowing for a correspondingly small SN 506 field (e.g., 3-4 outstanding RLC PDUs allows use of a 3 bit SN 506 field). Some embodiments may employ a 3 or 11 bit SN field 506. Another embodiment may employ a 5 or 10 bit SN field 506. Embodiments are not limited to any particular field sizes.

A compressed/regular field (“C/R”) 504 identifies the length of the SN 506 field. In some embodiments, the C/R field consists of a single bit identifying a first or second SN 506 field length, but embodiments are not limited to any particular field sizes. In some embodiments, the C/R value is established during initialization of operations between a transmitting unit and a receiving unit, such embodiments may not include the C/R field 504 as part of the RLC header.

A “POLL” field 508 can be included to request that an AM RLC receiver send an RLC status report to an AM RLC transmitter. The RLC status report includes information regarding RLC PDUs received and RLC PDUs not received. In some embodiments, the POLL field consists of a single bit, but embodiments are not limited to any particular field size.

A resegmentation field (“RESEG”) 510 identifies the presence of a portion of the header (i.e., a sub-header) containing resegmentation information, and thus indicates whether the RLC PDU contains a PDU or a PDU segment. In some embodiments, a resegmentation sub-header is included only when outstanding RLC PDUs that have not been successfully received are re-segmented for retransmission. The resegmentation sub-header identifies the offset of portion of a PDU (i.e., a segment) from the start of the original PDU. The resegmentation sub-header also identifies the end of the original PDU when resegmentation is performed. In some embodiments, the resegmentation sub-header comprises an integral number of bytes, thus enhancing header parsing efficiency. In some embodiments, the RESEG field 510 consists of a single bit, but embodiments are not limited to any particular field size.

An SDU segmentation field (“SDUSEG”) 512 identifies the presence of a portion of the header (i.e., a sub-header) containing information regarding the segments of multiple RLC SDUs (i.e., PDCP PDUs 408, 410) in the RLC PDU 414. The reassembly sub-header is included if the RLC PDU 414 includes multiple RLC SDUs or one or more RLC SDU segments. In some embodiments, the reassembly sub-header comprises an integral number of bytes, thus enhancing header parsing efficiency. In some embodiments, the SDUSEG field 512 consists of a single bit, but embodiments are not limited to any particular field size.

A portion of the header comprising the resegmentation sub-header includes a segment offset (“SO”) field 514 and an end flag (“EF”) field 516. The SO field 514 identifies the offset of the starting byte of the current RLC PDU in the original (un-segmented) PDU that was segmented. In some embodiments, the SO field 514 specifies the location (e.g., the byte location) in the payload or data portion of the original PDU where the present PDU segment should be written to reconstruct the original PDU. In some embodiments, the SO field 516 consists of 15 bits, but embodiments are not limited to any particular field size.

The resegmentation sub-header also includes an end flag (“EF”) field 516 that indicates whether the present segment (i.e., the segment to which the sub-header pertains) is the last segment of the original PDU. That is, whether the last byte of the present segment corresponds to the last byte of the original segment. In some embodiments, the EF field 518 consists of a single bit, but embodiments are not limited to any particular field size.

A portion of the header comprising the reassembly sub-header includes a length field (“LEN”) 522 and an extension field (“E”) 520. The reassembly header contains information used to reassemble RLC SDU(s) or PDCP PDU(s). Some embodiments include an instance of the reassembly sub-header for each PDCP PDU or portion of a PDCP PDU included in the RLC PDU. Some embodiments include one fewer instance of the reassembly sub-header than the number of PDCP PDUs or portions of a PDCP PDU included in the RLC PDU. In some such embodiments the first reassembly sub-header present corresponds to the first PDCP PDU in the RLC PDU, and the length of the last PDU portion not associated with a reassembly sub-header is determined using RLC PDU length information derived, for example, from the MAC header, in conjunction with the given reassembly sub-header(s).

The LEN field 522 indicates the length of the corresponding portion of a PDCP PDU included in the RLC PDU. In some embodiments, the LEN 522 field is 11 bits in length, but embodiments are not limited to any particular field size.

The E field 520 indicates the presence of an additional reassembly sub-header, and thus the presence of another PDCP PDU in the RLC PDU. Note that in some embodiments, the E field 520 value indicates the presence of one last PDCP PDU or at least 2 more PDCP PDUs because one fewer reassembly sub-headers than PDCP PDUs are included in the RLC PDU. In some embodiments, the E 520 field consists of a single bit, but embodiments are not limited to any particular field size.

As explained above, embodiments of the header and sub-headers of the present disclosure consist of an integer number of bytes. Embodiments having selected field lengths not totaling an integer number of bytes may add reserved fields 524 to ensure that the header/sub-header is byte aligned. For example, if an RLC header includes a single reassembly sub-header consisting of an 11 bit LEN field and a single bit E field, then a 4 bit RSRV field may be included to byte align the sub-header. Note, however, that given the same field size no RSRV field is necessary when an even number of reassembly sub-headers is included.

The RLC header can include a fragment control (“FC”) field 518 that indicates whether a PDCP segment is a complete PDCP PDU, the first portion of a PDCP PDU, the last portion of PDCP PDU, or a middle portion of the PDCP PDU. In some embodiments, the FC field may be 2 bits in length, but embodiments are not limited to any particular field size. Embodiments may encode the segment information in a variety of ways. In some embodiments, segment information may be encoded as shown in Table 1 or Table 2, but embodiments encompass all encodings of segmentation information.

TABLE 1
FC Encoding

| FC | PDCP PDU Portion |
|---|---|
| 00 | Complete |
| 01 | First Portion |
| 10 | Last Portion |
| 11 | Middle Portion |

TABLE 2
FC Encoding

| FC | PDCP PDU Portion |
|---|---|
| 00 | 1^{st} byte is start of segment |
| | Last byte is end of segment |
| 01 | 1^{st} byte is start of segment |
| | Last byte is not end of segment |
| 10 | 1^{st} byte is not start of segment |
| | Last byte is end of segment |
| 11 | 1^{st} byte is not start of segment |
| | Last byte is not end of segment |

Various embodiments of an RLC PDU header may include different combinations of the above-described fields. For example, an RLC PDU header for AM data can include D/C 502, SN 506, POLL 508, RESEG 510, SDUSEG 512, and FC 518 fields, and further include SO 514 and EF 516 fields for resegmented data, and E 520 and LEN 522 fields for multiple SDUs. Similarly, an RLC PDU header for UM data can include SN 506, SDUSEG 512, and FC 518 fields. Embodiments provide byte aligned headers and sub-headers, thus, embodiments including fields resulting in a non-integer number of header or sub-header bytes can include RSRV 524 fields to provide byte alignment.

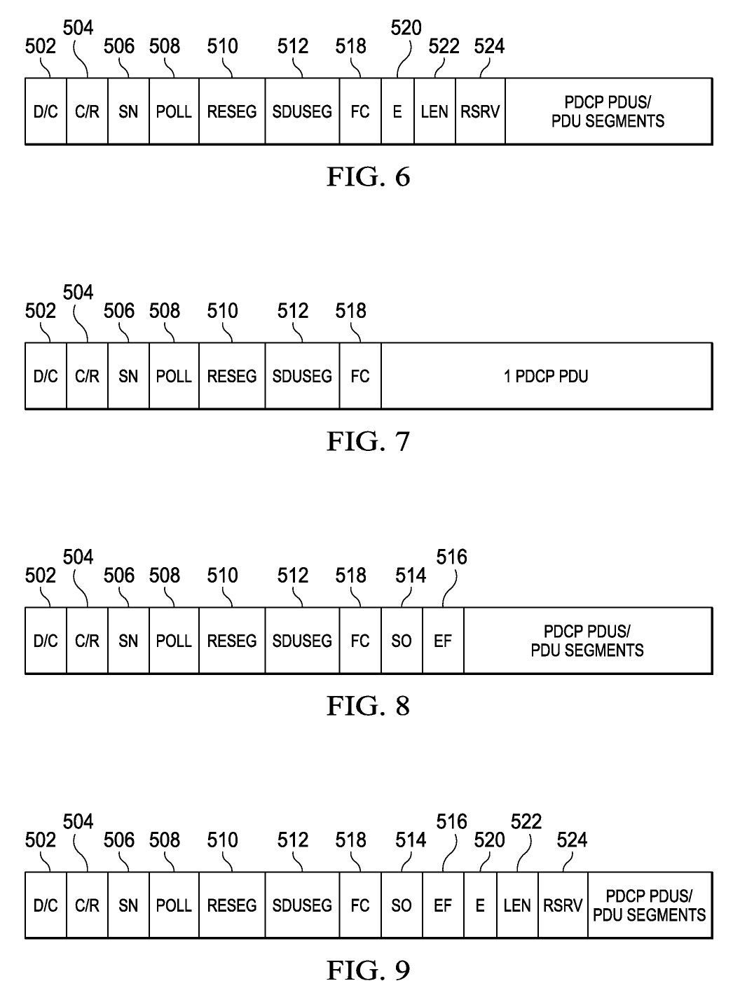

FIG. 6 shows an illustrative RLC PDU including 2 RLC SDUs with no resegmentation and a corresponding RLC PDU header in accordance with various embodiments. The exemplary header includes a D/C field 502 for specifying that the PDU is a data PDU. A C/R field 504 is included to specify the SN field 506 size, though some embodiments will not require the C/R field 504 as explained above. The POLL field 508 allows for request of a status return from the receiving entity. The SN field 506 is included to ensure in sequence delivery to the layer/sub-layer above the RLC sub-layer. RESEG 510 and SDUSEG 512 fields indicate the presence of corresponding sub-headers. In this particular example, the RESEG field 510 is set to indicate no resegmentation, and the SDUSEG field 512 is set to indicate the presence of a reassembly sub-header, and consequently, indicate in at least some embodiments, that portions of two RLC SDUs are included in the RLC PDU. The LEN field 522 contains the length of the first portion of an RLC segment in the RLC PDU, and the E field 520 is set to indicate that no additional reassembly sub-headers follow the present reassembly sub-header. A receiving entity will compute the length of the second RLC SDU portion included in the RLC PDU based on the LEN field 522 and the length of the RLC PDU as given, for example, in the MAC header. The FC field 518 is set to indicate the segmentation of RLC SDUs in accordance with a selected encoding scheme, for example, that of Table 2 above. The fields of the reassembly sub-header are sized such that the sub-header is byte aligned by inclusion of the RSRV field 524. Moreover, the header as a whole consists of an integer number of bytes.

An RLC PDU including more that 2 RLC SDUs with no resegmentation may be constructed by adding an E field 520 and a LEN field 522 for each RLC SDU added to the RLC PDU.

FIG. 7 shows an illustrative RLC PDU including a single RLC SDU with no resegmentation and a corresponding RLC PDU header in accordance with various embodiments. The exemplary header includes a D/C field 502 for specifying that the PDU is a data PDU. A C/R field 504 is included to specify the SN field 506 size, though some embodiments will not require the C/R field 504 as explained above. The POLL field 508 allows for request of a status return from the receiving entity. The SN field 506 is included to ensure in sequence delivery to the layer/sub-layer above the RLC sub-layer. RESEG 510 and SDUSEG 512 fields indicate the presence of corresponding sub-headers. In this particular example, the RESEG field 510 is set to indicate no resegmentation, and the SDUSEG field 512 is set to indicate that no reassembly sub-headers are included, and consequently, indicate in at least some embodiments, that the RLC PDU includes at least a portion of only one RLC SDU. A receiving entity will compute the length of the RLC SDU portion included in the RLC PDU based on the length of the RLC PDU as given, for example, in the MAC header. The FC field 518 is set to indicate the segmentation of the included RLC SDU in accordance with a selected encoding scheme, for example, that of Table 2 above. The header as a whole consists of an integer number of bytes.

FIG. 8 shows an illustrative RLC PDU including a single RLC SDU with resegmentation and a corresponding RLC PDU header in accordance with various embodiments. The exemplary header includes a D/C field 502 for specifying that the PDU is a data PDU. A C/R field 504 is included to specify the SN field 506 size, though some embodiments will not require the C/R field 504 as explained above. The POLL field 508 allows for request of a status return from the receiving entity. The SN field 506 is included to ensure in sequence delivery to the layer/sub-layer above the RLC sub-layer. RESEG 510 and SDUSEG 512 fields indicate the presence of corresponding sub-headers. In this particular example, the RLC SDU is resegmented for retransmission, therefore the RESEG field 510 is set to indicate resegmentation and a resegmentation sub-header is included. The SDUSEG field 512 is set to indicate omission of a reassembly sub-header because only one RLC SDU is included in the RLC PDU. The SO field 514 identifies the starting byte location of the portion of an RLC SDU included in the present RLC PDU in the original RLC PDU (i.e., the un-resegmented RLC PDU). The EF field 516 is set to indicate whether this portion of an RLC SDU is the last segment of the original RLC PDU. The FC field 518 is set to indicate the segmentation of RLC SDUs in accordance with a selected encoding scheme, for example, that of Table 2 above. The fields of both the resegmentation sub-header and the header as a whole include an integer number of bytes.

FIG. 9 shows an illustrative RLC PDU including two RLC SDUs with resegmentation and a corresponding RLC PDU header in accordance with various embodiments. The exemplary header includes a D/C field 502 for specifying that the PDU is a data PDU. A C/R field 504 is included to specify the SN field 506 size, though some embodiments will not require the C/R field 504 as explained above. The POLL field 508 allows for request of a status return from the receiving entity. The SN field 506 is included to ensure in sequence delivery of data units to the layer/sub-layer above the RLC sub-layer. RESEG 510 and SDUSEG 512 fields indicate the presence of corresponding sub-headers. In this particular example, the RLC SDUs are resegmented for retransmission, therefore the RESEG field 510 is set to indicate resegmentation and a resegmentation sub-header is included. The SDUSEG field 512 is set to indicate inclusion of a reassembly sub-header because more than one RLC SDU is included in the RLC PDU. The SO field 514 identifies the starting byte location of the portion of an RLC SDU included in the present RLC PDU in the original RLC PDU (i.e., the un-resegmented RLC PDU). The EF field 516 is set to indicate whether this RLC PDU includes the last segment of the original RLC PDU. The LEN field 522 contains the length of the first portion of an RLC segment in the RLC PDU, and the E field 520 is set to indicate that no additional reassembly sub-headers follow the present reassembly sub-header. A receiving entity will compute the length of the second RLC SDU portion included in the RLC PDU based on the LEN field 522 and the length of the RLC PDU as given, for example, in the MAC header. The FC field 518 is set to indicate the segmentation of RLC SDUs in accordance with a selected encoding scheme, for example, that of Table 2 above. The aggregate fields of the resegmentation sub-header, the reassembly header and of the header as a whole include an integer number of bytes. Some embodiments include one or more RSRV fields 524 to affect byte alignment of a sub-header. Note that An RLC PDU including more that 2 RLC SDUs with resegmentation may be constructed by adding an E field 520 and a LEN field 522 (a reassembly sub-header) for each RLC SDU added to the RLC PDU.

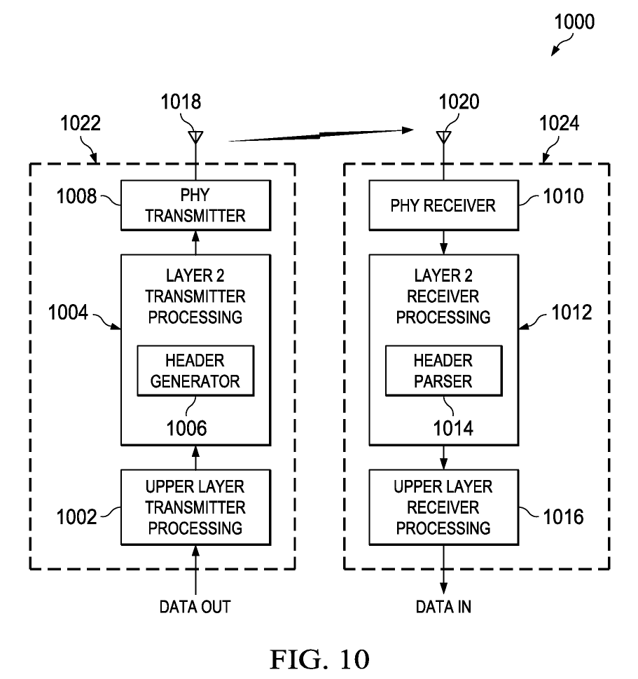

FIG. 10 shows an illustrative system 1000 for constructing and transmitting, and for receiving and parsing data link layer headers in accordance with various embodiments. The exemplary system 1000 comprises a transmitting unit 1022 (e.g., base station 101) and a receiving unit 1024 (e.g., UE 109). The transmitting unit 1022 comprises an upper layer transmitter processing module 1002, a layer 2 transmitter processing module 1004, a physical layer transmitter 1008, and an antenna 1018. The layer 2 transmitter processing module 1004 further comprises a header generator 1006. Data to be transmitted, for example, voice data, text, video, etc is provided to the upper layer transmitter processing module 1002, which performs processing for protocol layer 3 and above. The PDUs generated by the upper layer transmitter processing module 1002 are provided to the layer 2 transmitter processing module 1004 which processes the PDUs in accordance with data link layer requirements, including, in some embodiments, PDCP, RLC, and MAC sub-layer processing. The header generator 1006 adds headers to the data units produced at each sub-layer during layer 2 processing. The header generator 1006 provides, for example the RLC header/sub-headers and the PDCP header (i.e., SN 412) described herein.

Embodiments of the header generator 1006 add an SN field 412 to the PDCP header in the PDCP sub-layer processing. In the RLC sub-layer processing, embodiments of the header generator 1006, provide RLC PDU headers and sub-headers including at least some of D/C 502, C/R 504, SN 506, POLL 508, RESEG 510, SDUSEG 512, SO 514, EF 516, FC 518, E 520, and LEN 522 fields. To enhance header processing efficiency in the receiving unit 1024, embodiments of the header generator 1006 provide byte aligned headers and sub-headers in the RLC layer header generation.

The header generator 1006 can be implemented as a processor executing associated header generation software programming stored in a memory device to provide the headers herein described. The processor may include a digital signal processor, a microcontroller, microprocessor, or other circuitry adapted to perform the operation required to construct headers. The term processor as used herein generally refers to a computer central processing unit (“CPU”), embodiments of which comprise a control unit that fetches, decodes, and executes instructions, an arithmetic and logic unit (“ALU”) that performs logical and mathematical operations, registers for storage of values used in processor operation, and various other logic. Some embodiments of a processor comprise volatile memory and/or non-volatile memory for storage of data and instructions.

Layer 2 PDUs are provided to the physical layer transmitter 1008 for transmission to the receiving unit 1024. The physical layer transmitter 1008 includes various modulation and radio frequency (“RF”) interface circuits. Radio frequency signals are provided to antenna 1018 for transmission over-the-air to the receiving unit 1024. Although system 1000 illustrates a wireless system, system 1000 may be adapted to various different transmission mediums by included the appropriate physical layer transmitter 1008 and physical layer receiver 1010.

Similar to the header generator 1006, the upper layer transmitter processing module 1002, layer 2 transmitter processing module 1004, and the physical layer transmitter 1008 can be implemented by a processor and associated software programming in conjunction with various other circuits, such as RF circuits.

Receiving unit 1024 comprises an antenna 1020, a physical layer receiver 1010, a layer 2 receiver processing module 1012, and an upper layer receiver processing module 1016. The layer 2 receiver processing module 1012 further comprises a header parser 1014. Radio frequency signals transmitted by transmitting unit 1022 are detected by antenna 1020 and provided to the physical layer receiver 1010. Physical layer receiver 1010 down-converts to baseband, digitizes, and demodulates the signals. Various other functions, for example, error detection may be applied at the physical layer level.

The physical layer receiver 1010 provides layer 2 PDUs extracted from the received signals to the layer 2 receiver processing module 1012. Layer 2 receiver processing module 1012 processes the PDUs in accordance with data link layer requirements, including, in some embodiments, MAC, RLC, and PDCP sub-layer processing to reconstruct the upper layer PDUs provided by upper layer transmitter processing module 1002 to layer 2 transmitter processing module 1004 of transmitting unit 1022. The headers included in the layer 2 PDUs contain the information required to reconstruct the upper layer PDUs. The header parser 1014 decodes the various layer 2 headers described herein (e.g., the RLC headers and sub-headers, and PDCP header), to provide the information and direction required to reconstruct the upper layer PDUs.

Embodiments of the header parser 1014 parse received layer 2 headers and sub-headers to extract and decode an SN field 412 of the PDCP header in the PDCP sub-layer processing. In the RLC sub-layer processing, embodiments of the header parser 1014, parse RLC PDU headers and sub-headers to extract and decode at least some of D/C 502, C/R 504, SN 506, POLL 508, RESEG 510, SDUSEG 512, SO 514, EF 516, FC 518, E 520, and LEN 522 fields. To enhance header parsing efficiency the RLC sub-layer headers and sub-headers processed by header parser 1014 are byte aligned.

Similar to the header generator 1006, the header parser 1014, upper layer receiver processing module 1016, layer 2 receiver processing module 1012, and the physical layer receiver 1010 can be implemented by a processor and associated software programming in conjunction with various other circuits, such as RF circuits.

Upper layer PDUs, constructed by layer 2 receiver processing module 1012 are provided to upper layer receiver processing module 1016 which processes the PDUs to provide data to a user.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A transmitter, comprising:
a protocol layer header generator that generators a header for a first protocol data unit;
wherein the header generator provides a first header comprising a first sequence number field that determines the order in which a receiving entity presents at least a portion the first data unit to a higher protocol layer and the sequence number field varies in length.

2. The transmitter of claim 1, wherein the first header further comprises a Data/Control field that identifies the first data unit as containing one of data and control information.

3. The transmitter of claim 1, wherein the first header further comprises a Poll field that requests return of status information from the receiving entity.

4. The transmitter of claim 1, wherein the first header further comprises a Resegmentation field that indicates whether a Resegmentation sub-header is included in the first header, the Resegmentation sub-header comprising information regarding the resegmentation of a data unit.

5. The transmitter of claim 1, wherein the first header further comprises a Segmentation field that indicates whether a Reassembly sub-header is included in the first header, the Reassembly sub-header comprising information regarding upper level data units in the first data unit.

6. The transmitter of claim 1, wherein the first header further comprises a Fragment Control field that indicates whether the first data unit includes at least one data segment selected from a group consisting of a complete upper layer data unit, a first portion of an upper layer data unit, and a last portion of an upper layer data unit.

7. The transmitter of claim 1, wherein the first header further comprises a Resegmentation sub-header comprising at least one of a Segment Offset field that indicates the byte location of at least a portion of the first data unit's data in an un-resegmented data unit and an End Flag that indicates whether the first data unit includes a last portion of an un-resegmented data unit.

8. The transmitter of claim 1, wherein the first header further comprises a Reassembly sub-header comprising at least one of an Extension field that indicates whether an additional Reassembly sub-header follows the Reassembly sub-header and a Length field that indicates the size of at least a portion of an upper level data unit included in the first data unit.

9. The transmitter of claim 1, wherein the first header further comprises one fewer Reassembly sub-headers than the number of different upper level data units included in the first data unit.

10. The transmitter of claim 1, wherein the first header is Radio Link Control (“RLC”) header for an RLC data unit.

11. The transmitter of claim 1, wherein each header and each sub-header provided by the header generator consists of an integer number of bytes.

12. The transmitter of claim 1, wherein the transmitter is a long-term evolution (“LTE”) wireless transmitter.

13. The transmitter of claim 1, wherein the header generator provides a second header comprising a second sequence number field that determines the order in which a receiving entity should present a second data unit to a higher protocol layer.

14. The transmitter of claim 15, wherein the second header is Packet Data Convergence Protocol (“PDCP”) header for a PDCP data unit.

15. A receiver, comprising:
a protocol layer header parser that parses a header of a first protocol data unit;
wherein the header parser parses a first header comprising a first sequence number field that determines the order in which at least a portion of the first data unit is presented to a higher protocol layer, and the sequence number field varies in length.

16. The receiver of claim 17, wherein the first header further comprises a Data/Control field that identifies the first data unit as containing one of data and control information.

17. The receiver of claim 17, wherein the first header further comprises a Poll field that requests return of status information from the receiving entity.

18. The receiver of claim 17, wherein the first header further comprises a Resegmentation field that indicates whether a Resegmentation sub-header is included in the first header, the Resegmentation sub-header comprising information regarding the resegmentation of a data unit.

19. The receiver of claim 17, wherein the first header further comprises a Segmentation field that indicates whether a Reassembly sub-header is included in the first header, the Reassembly sub-header comprising information regarding upper level data units in the first data unit.

20. The receiver of claim 17, wherein the first header further comprises a Fragment Control field that indicates whether the first data unit includes at least one data segment selected from a group consisting of a complete upper layer data unit, a first portion of an upper layer data unit, and a last portion of an upper layer data unit.

21. The receiver of claim 17, wherein the first header further comprises a Resegmentation sub-header comprising at least one of a Segment Offset field that indicates the byte location of at least a portion of the first data unit's data in another data unit, and an End Flag that indicates whether the first data unit includes a last portion of an un-resegmented data unit.

22. The receiver of claim 17, wherein the first header further comprises a Reassembly sub-header comprising at least one of an Extension flag that indicates whether an additional Reassembly sub-header follows the present Reassembly sub-header, and a Length field that indicates the size of at least a portion of an upper level data unit included in the first data unit.

23. The receiver of claim 17, wherein the first header further comprises one fewer Reassembly sub-headers than the number of different upper level data units included in the first data unit.

24. The receiver of claim 17, wherein the first header is Radio Link Control (“RLC”) header for an RLC data unit.

25. The receiver of claim 17, wherein each header and each sub-header provided by the header generator consists of an integer number of bytes.

26. The receiver of claim 17, wherein the transmitter is a long-term evolution (“LTE”) wireless transmitter.

27. The receiver of claim 17, wherein the header parser parses a second header comprising a second sequence number field that determines the order in which a receiving entity should present a second data unit to a higher protocol layer.

28. The receiver of claim 17, wherein the second header is Packet Data Convergence Protocol (“PDCP”) header for a PDCP data unit.
